(19) United States
(12) Patent Application Publication
(10) Pub. No.: US 2026/0051807 A1
(43) Pub. Date: Feb. 19, 2026

(54) DIFFERENTIAL MODE FILTER WITH A VARIABLE IMPEDANCE

(71) Applicant: Airbus Operations SAS, TOULOUSE (FR)

(72) Inventors: Patrick BAREAUD, TOULOUSE (FR); Gustavo SATHLER ZAPPULLA, TOULOUSE (FR)

(21) Appl. No.: 19/291,141

(22) Filed: Aug. 5, 2025

(30) Foreign Application Priority Data
Aug. 15, 2024 (FR) FR2408941

(51) Int. Cl. H02M 1/12; H02M 1/00

(52) U.S. Cl. CPC H02M 1/126; H02M 1/007

(57) ABSTRACT

A differential mode filter with a variable inductance, the variable inductance having a primary winding coupled to a secondary winding, the secondary winding having a switch connected in series and configured so that when the switch is in the closed position, the variable inductance has a first inductance value, and when the switch is in the open position, the variable inductance has a second inductance value. The first inductance value is lower than the second inductance value.

### CROSS-REFERENCE TO RELATED APPLICATIONS

This claims the benefit of French Patent Application No. FR2408941, filed on Aug. 15, 2024, the entire disclosures of which are incorporated herein by way of reference.

### FIELD OF THE INVENTION

The present invention relates to a differential mode filter with a variable impedance, and more particularly to a differential mode filter comprising an inductor having an active circuit which makes it possible to change its inductance.

### BACKGROUND OF THE INVENTION

The design of critical applications, for example of electrical networks of aircraft, must ensure that the network remains stable under all operating conditions. In the context of stability analyses, one of the most widely used criteria (because robust for critical applications) is the Middlebrook criterion.

Such electrical networks typically comprise at least two converters in cascade. Differential mode filters are used at the input and at the output of these converters in order to guarantee in particular the filtering of harmonics related to chopping frequencies. The most widely used topology is the LC filter, without or with damping, in particular three main differential filter configurations with damping (parallel RC, parallel RL and series RL).

However, when converters in cascade are bidirectional, the guarantee of stability by the Middlebrook criterion may no longer be demonstrated with traditional filters. Given that the output impedance of the upstream equipment must be lower than the input impedance of the downstream equipment, when the direction of the power flow changes, the equipment which was a load becomes a source (and vice versa), and this requirement on the respective impedance values is no longer met. Without modifying the impedance profiles in accordance with the operating mode (load or source), stability in the case of bidirectional converters in cascade may no longer be demonstrated according to the Middlebrook criterion.

The techniques mentioned in this section should not be presumed to belong to the prior art simply because they have been mentioned. Similarly, a problem mentioned in this same section should not be presumed to have been previously identified in the prior art simply because it has been mentioned.

### SUMMARY OF THE INVENTION

Embodiments of the present invention have been developed based on the developers' understanding of the gaps associated with the prior art. The invention generally proposes a differential mode filter which varies its impedance, for example depending on the “source” or “load” operating mode of an item of equipment (for example a converter) with which it is used. The differential mode filter in accordance with the invention comprises an inductor having an active circuit which makes it possible to change its inductance.

More particularly, the present invention comprises, in various embodiments, a differential mode filter comprising a variable inductance, the variable inductance comprising a primary winding coupled to a secondary winding, the secondary winding comprising a switch connected in series, configured so that:
when the switch is in the closed position, the variable inductance has a first inductance value, and when the switch is in the open position, the variable inductance has a second inductance value; and
the first inductance value is lower than the second inductance value.

In one embodiment of the filter, the secondary winding further comprises a first additional impedance in series with the switch.

In another embodiment of the filter, the secondary winding further comprises a second additional impedance in parallel with the switch and the first additional impedance.

In another embodiment of the filter, the switch is bidirectional.

In another embodiment of the filter, the switch is of electronic type.

The present invention also comprises, in various embodiments, an electrical network comprising two bidirectional converters, a first and a second, connected in cascade, the first and second bidirectional converter being electrically connected to a first and a second differential mode filter, respectively, as above, the first differential mode filter being electrically connected to the second differential mode filter, a first and second switch of the first and second differential mode filter, respectively, being configured so that:
when the first bidirectional converter is in source mode, and the second converter is in load mode: the first switch is closed, and the second switch is open; and
when the second converter is in source mode, and the first converter is in load mode: the second switch is closed, and the first switch is open.

The present invention also comprises, in various embodiments, an aircraft comprising the electrical network above.

In the context of the present description, unless expressly stated otherwise, the words “first”, “second”, “third”, etc. have only been used as adjectives for the sole purpose of making it possible to distinguish between the nouns that they accompany, and not to describe a particular relationship between these nouns.

The implementations of the present invention each have at least one of the subjects and/or aspects mentioned above, but do not necessarily have all of them.

Additional and/or alternative features, aspects and advantages of the implementations of the present invention will emerge from the following description, from the attached drawings and from the appended claims.

### BRIEF DESCRIPTION OF THE DRAWINGS

For a better understanding of the present invention, reference is made to the following description which should be used in conjunction with the attached drawings, where:

FIG. 1 shows an inductance diagram having an active circuit in one embodiment of the invention;

FIG. 2 shows an inductance modelling diagram having a secondary winding equivalent to a transformer;

FIG. 3 shows Bode plots associated with a simulation of the inductance in one embodiment of the invention;

FIG. 4A shows an inductance diagram having an active circuit in an embodiment of the invention;

FIG. 4B also shows an inductance diagram having an active circuit in an embodiment of the invention; and

FIG. 5 shows an aircraft comprising an exemplary implementation of an electrical network implementing the invention.

It should be noted that, unless explicitly stated otherwise, the drawings are not to scale. Finally, identical elements from one drawing to another bear the same numerical reference.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and again not to define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future. Thus, for example, it will be understood by a person skilled in the art that all the functional diagrams represent conceptual views of examples of circuits incorporating the principles of the present invention.

This being said, a few non-limiting examples will now be considered in order to illustrate various implementations of the present invention.

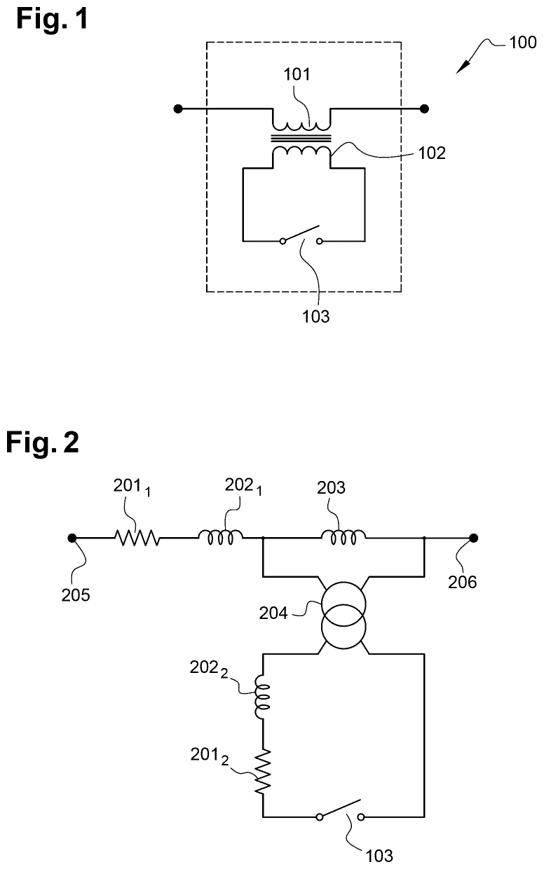

FIG. 1 shows an inductance diagram having an active circuit 100 in one embodiment of the invention. This inductance may in particular be used in the differential mode filters of LC type mentioned in the introduction. It comprises a primary winding 101 coupled to a secondary winding 102. A switch 103 makes it possible, in the closed position, to create a short circuit on the secondary winding 102.

This inductance having the secondary winding 102 is equivalent to a transformer which may be modelled as in FIG. 2. In this model, inductances 2021 and 2022 correspond to the primary winding 101 and to the secondary winding 102, respectively, of given respective values, and are stray inductances due to the part of the magnetic flux which is not closed off by the magnetic circuit.

An inductance 203 is the magnetization inductance of the transformer, which normally has a high value due to the high magnetic permeability of the core of the transformer but which may be controlled by introducing an air gap (or equivalently, by using magnetic materials made of iron powder having a distributed air gap).

Resistors 2011 and 2012, corresponding to the primary winding 101 and the secondary winding 102, respectively, and a transformer 204, considered to be an ideal transformer, complete this model.

The current flows between the points 205 and 206 of the equivalent of the primary winding 101. Only the AC components of this current are transmitted to the equivalent of the secondary winding 102.

When the switch 103 is open, the equivalent inductance in the power path of the filter is equal to the sum of the stray inductance 2021 of the primary and the magnetization inductance 203 of the transformer. The sum of these inductances may be set by design to have the total needed inductance required for differential mode filtering when the equipment is operating as a load. If the resistance and inductance values are respectively:
resistance 2011 of the primary winding 101=Rₛ₁
stray inductance 2021 of the primary winding 101=Lₗₑₐₖ₁
magnetization inductance 203 of the primary winding 101=Lₘ
then the resulting cutoff frequency (in Hz) by the component in this state is obtained using Equation 1: f_{cutoff}=Rₛ₁/2π×(Lₘ+Lₗₑₐₖ₁).

When the switch 103 is closed, the secondary winding will create a path of lower inductance for the AC components of the current. If the value of the magnetization inductance 203 is considerably higher (of the order of 10 times higher) than that of the stray inductance 2022 of the secondary, the equivalent inductance of the power path for the AC components may be approximated by the sum of the stray inductances 2021 and 2022 of the primary and secondary windings, respectively. This sum may be set by design to have a very low value, required for differential mode filtering when the equipment is operating as a source. If the resistance and inductance values are respectively:
resistance 2012 of the secondary winding 102=Rₛ₂
stray inductance 2022 of the secondary winding 102=Lₗₑₐₖ₂
then the resulting cutoff frequency (in Hz) by the component in this state is obtained using Equation 2: f_{cutoff}=(Rₛ₁+Rₛ₂)/2π×(Lₗₑₐₖ₁+Lₗₑₐₖ₂).

To demonstrate the effectiveness of the solution of the invention, a simulation diagram obtained using the LTSpice™ tool is presented. The parameter values considered are for example:

$$\begin{matrix}{R}_{s 1} = {R}_{s 2} = 5 mOhms \\ {L}_{l e a k 1} = {L}_{l e a k 2} = 5 micro H \\ {L}_{m} = 1000 microH .\end{matrix}$$

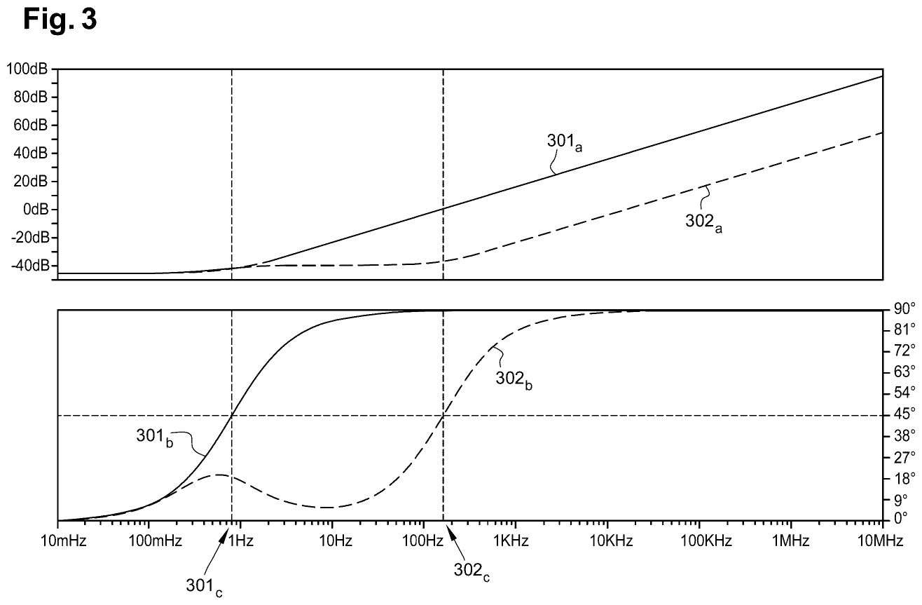

The results are shown by the Bode plots in FIG. 3.

The curves 301a and 301b show the magnitude and the phase, respectively, in the case where the switch 103 is in the open state. The curves 302a and 302b show the magnitude and the phase, respectively, in the case where the switch 103 is in the closed state.

The gradient of the magnitude curves 301a and 302a after the characteristic cutoff frequencies of the two systems is 20 dB/dec, this corresponding to an inductive response as expected. The cutoff frequencies have been identified by the arrows 301c and 302c on the phase curves 301b and 302b, corresponding to the frequencies which cross the phase of 45°.

Thus, the value of the cutoff frequency calculated using Equation 1 above is 0.792 Hz, which is close to the value 301c of 0.794 Hz resulting from the simulation. Similarly, the value of the cutoff frequency calculated using Equation 2 above is 159.1 Hz, which is close to the value 302c of 158.9 Hz resulting from the simulation. This analysis demonstrates the effectiveness of the proposed solution.

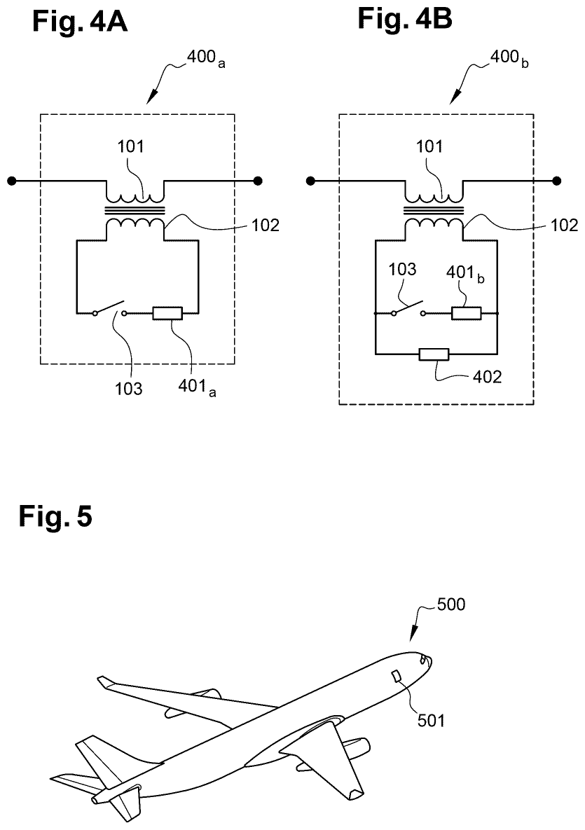

Examples of inductance diagram variants 400a and 400b having an active circuit in other embodiments of the invention are proposed in FIG. 4. These inductances also comprise the primary winding 101 coupled to the secondary winding 102, while the switch 103 makes it possible, in the closed position, to create a short circuit on the secondary winding 102. Compared to the inductance diagram of FIG. 1, the variant 400a comprises an additional impedance 401a in series with the switch 103 in the secondary winding circuit 102. Compared to the variant 400a, the variant 400b also comprises an impedance 401b in series with the switch 103, and an additional impedance 402 in parallel.

All these variants may be analysed by a person skilled in the art, in the same way as the above analysis relating to the inductance diagram of FIG. 1.

Whatever the variant, the invention allows the use of the same magnetic materials (ferrite, iron powder, nanocrystalline, amorphous), core geometries, and technologies used for conventional differential mode filters.

In the case where the stray inductances have to be very small, it is necessary to have a high coupling factor between the primary and secondary windings. In this case, technologies of intertwined coils or coaxial wires may be preferable.

The transformation ratio between the primary and secondary windings may be chosen as a function of the alternating current and voltage levels in the frequency domain. A high transformation ratio allows the use of a small number of turns at the secondary winding and also a lower voltage, this allowing the use of a switch of a lower voltage capacitance. Nonetheless, the current obtained at the secondary winding will be greater.

The switch 103 used at the secondary winding is advantageously bidirectional, given that the current which will flow is alternating. For the sake of speed, the use of electronic switches based on semiconductors is preferable (for example: an insulated gate field-effect transistor, a modulation-doped field-effect transistor, or a bipolar junction transistor, respectively: MOSFET, HEMT, BJT). Depending on the turns ratio, it is preferable to use components with a low voltage drop in the closed state (or equivalently, a low on-state resistance), so that the device does not add more elements in series to the system.

The invention thus makes it possible in particular to dynamically (i.e.: during operation) modify the impedance of differential mode filters associated with bidirectional converters, depending on the operating mode of said converters as a source or as a load. This is necessary to demonstrate the stability of critical electrical networks by way of a Middlebrook criterion, a criterion which is currently used in the analysis of networks in critical applications.

The aircraft 500 shown in FIG. 5 comprises an exemplary implementation of an electrical network 501 implementing the invention. The electrical network comprises at least two bidirectional converters, a first and a second, connected in cascade. These bidirectional converters may be, in turn, a source and a load in relation to each other. Each of the bidirectional converters being equipped, at the input and at the output, with a differential mode filter according to the invention, the actions on the respective switches of these various differential mode filters make it possible to ensure that the output impedance of the source bidirectional converter is lower than the input impedance of the load bidirectional converter. Thus, if a first of the two bidirectional converters is in source mode (i.e.: the second is in load mode), the switch on its associated differential mode filter at the output will be closed, while the switch on the associated differential mode filter at the input to the second of the two converters will be closed. When the second of the two bidirectional converters is in source mode (i.e.: the first is in load mode), the switch on its associated differential mode filter at the output will be closed, while the switch on the associated differential mode filter at the input to the first of the two converters will be closed.

Modifications and improvements to the implementations described above of the present invention may occur to a person skilled in the art. The above description is illustrative by means of examples rather than limiting. The scope of the present invention is therefore limited solely by the scope of the claims below.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An electrical network comprising:
two bidirectional converters, a first bidirectional converter and a second bidirectional converter, connected in cascade, the first bidirectional converter and the second bidirectional converter being electrically connected to a first differential mode filter and a second differential mode filter, respectively, the first differential mode filter being electrically connected to the second differential mode filter, each of the first and the second differential mode filter comprising a variable inductance, each variable inductance comprising a primary winding coupled to a secondary winding, the secondary winding comprising a switch connected in series, configured so that:
when the switch is in a closed position, the variable inductance has a first inductance value, and when the switch is in an open position, the variable inductance has a second inductance value, the first inductance value lower than the second inductance value,
wherein a first switch of the first second differential mode filter and a second switch of the second differential mode filter, respectively, are configured so that:
when the first bidirectional converter is in a source mode, and the second bidirectional converter is in a load mode, the first switch is closed and the second switch is open; and
when the second bidirectional converter is in a source mode, and the first bidirectional converter is in a load mode, the second switch is closed and the first switch is open,
so as to ensure that an output impedance of a bidirectional converter in source mode is lower than an input impedance of a bidirectional converter in load mode.

2. The electrical network of claim 1, wherein the secondary winding of the first filter, the second filter, or both further comprises a first additional impedance in series with the switch.

3. The electrical network of claim 2, wherein the secondary winding of the first filter, the second filter, or both further comprises a second additional impedance in parallel with the switch and the first additional impedance.

4. The electrical network according to claim 1, wherein the switch of the first filter, the second filter, or both is bidirectional.

5. The electrical network according to claim 1, wherein the switch of the first filter, the second filter, or both is of an electronic switch.

6. An aircraft comprising:
the electrical network according to claim 1.
